(19) United States
(12) Patent Application Publication
(10) Pub. No.: US 2006/0019110 A1
(43) Pub. Date: Jan. 26, 2006

(54) Films

(75) Inventors: Hiroyuki Sato, Tsukuba-shi (JP); Yasuo Shinohara, Niihari-gun (JP); Hiroaki Kumada, Inashiki-gun (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 11/166,179

(22) Filed: Jun. 27, 2005

(30) Foreign Application Priority Data
Jun. 30, 2004 (JP) 2004-193262

(51) Int. Cl. B32B 15/00

(52) U.S. Cl. 428/474.4; 428/209

(57) ABSTRACT

The present invention provides a film comprising component A and component B, wherein the component A is at least one compound selected from a group consisting of aromatic polyamides, aromatic polyimides, and aromatic polyamideimides, and component B is a liquid crystal polymer showing optical anisotropy in molten state.

### BACKGROUND OF THE INVENTION

1. Field of the Invention

The invention relates films comprising one or more compounds selected from a group consisting of aromatic polyamides, aromatic polyimides, and aromatic polyamideimides.

2. Description of the Related Art

Films comprising one or more compounds selected from a group consisting of aromatic polyamides, aromatic polyimides, and aromatic polyamideimides are used for printed wiring boards, because of their lightweight and high-strength. For example, because a composition consisting of one or more compounds selected from a group consisting of aromatic polyamides, aromatic polyimides, and aromatic polyamideimides is difficult to make films, film comprising the composition and epoxy resins are known (for example, JP-A No. 09-324060).

However, film comprising one or more compounds, selected from a group consisting of aromatic polyamides, aromatic polyimides, and aromatic polyamideimides, and epoxy resins has 3.5% of high water absorbency. Then, there is a need for films having lower water absorbency.

### SUMMARY OF THE INVENTION

An object of the invention is to provide films comprising one or more compounds selected from a group consisting of aromatic polyamides, aromatic polyimides, and aromatic polyamideimides, and having low water absorbency.

The present inventors have studied intensively for producing such a film. They found that films obtained by combining one or more compounds selected from a group consisting of aromatic polyamides, aromatic polyimides and aromatic polyamideimides, and a liquid crystal polymer showing optical anisotropy in molten state, has lower water absorbency than that of conventional films.

Therefore, the present invention provides film comprising a component A and B:
Component A: one or more compounds selected from a group consisting of aromatic polyamides, aromatic polyimides, and aromatic polyamideimides.
Component B: a liquid crystal polymer showing optical anisotropy in molten state.

Because the film of the present invention has light weight, high-strength and low coefficient of thermal expansion, and the film has lower water absorbency than that of conventional films, the film is suitable for printed wiring board, more particularly for industrial application.

### PREFERABLE EMBODIMENT OF THE PRESENT INVENTION

A film of the present invention includes a following component B.

Component B: a liquid crystal polymer showing optical anisotropy in molten state.

A liquid crystal polymer showing optical anisotropy in molten state, used in the present invention, includes whole aromatic or semi-aromatic polyester, whole aromatic or semi-aromatic polyimide, whole aromatic or semi-aromatic polyesteramide and the like. A more preferable liquid crystal polymer is whole aromatic or semi-aromatic polyester, and a further preferable is whole aromatic polyester.

The polyester here is a polyester called “thermotropic liquid crystal polymer”. Examples thereof include:
(1) those comprising repeating units derived from an aromatic dicarboxylic acid, an aromatic diol, and an aromatic hydroxycarboxyic acid;
(2) those comprising repeating units derived from different kinds of aromatic hydroxycarboxylic acids;
(3) those comprising repeating units derived from an aromatic dicarboxylic acid and a aromatic diol; and
(4) those obtainable by the reaction of a polyester such as polyethylene terephthalate with an aromatic hydroxycarboxylic acid;
   and usually those form an anisotropic molten state at a temperature of 400° C. or lower.

Further, in place of the aromatic dicarboxylic acid, the aromatic diol, or the aromatic hydroxycarboxylic acid, ester derivatives thereof can be used. The aromatic dicarboxylic acid, the aromatic diol, and the aromatic hydroxycarboxylic acid may have a substituent such as a halogen atom, an alkyl group having 1 to 10 carbon atoms, an aryl group having 2 to 10 carbon atoms or the like, on the aromatic group.

Examples of repeating units of the liquid crystal polyester include the following (1) repeating units derived from aromatic dicarboxylic acid, (2) repeating units derived from aromatic diol, and (3) repeating units derived from hydroxycarboxyic acid, without being limited thereto.
(1) Repeating unit derived from aromatic dicarboxylic acid: 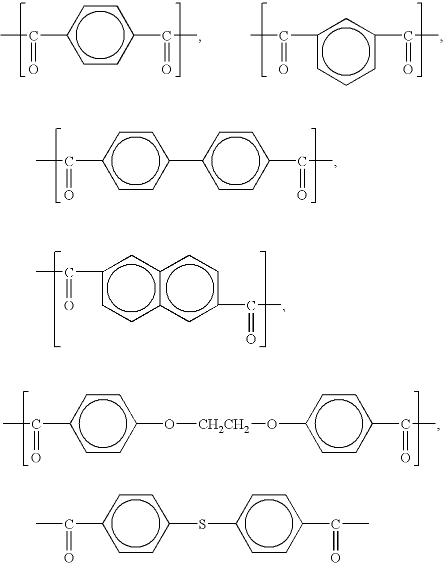
The aromatic ring in each of the above structural unit may be substituted with a halogen atom, an alkyl group having 1 to 10 carbon atoms, an aryl group having 2 to 10 carbon atoms or the like.
(2) Repeating unit derived from an aromatic diol: 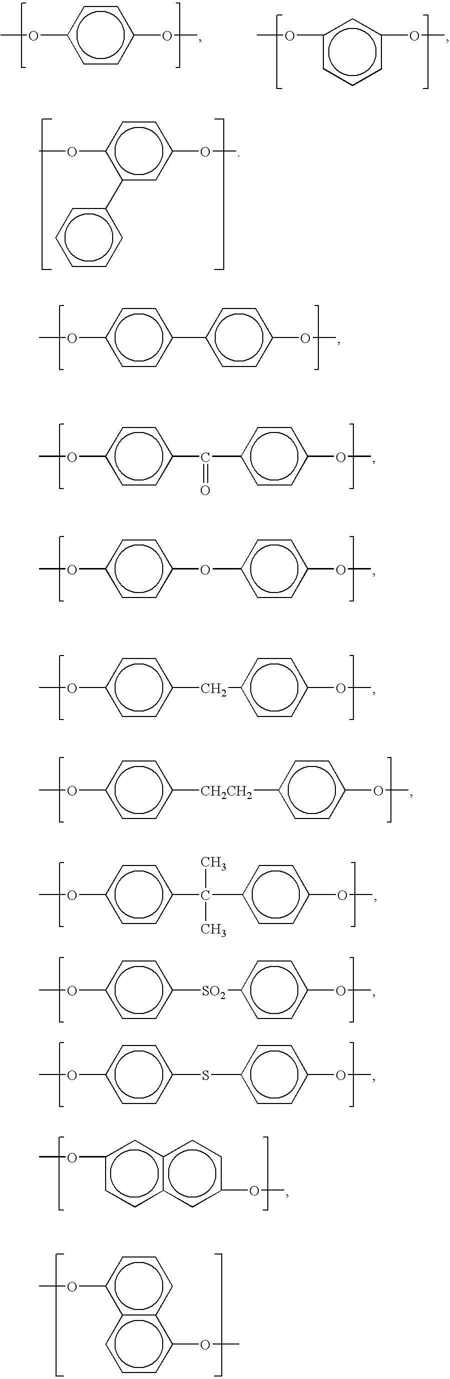
The aromatic ring in each of the above structural unit may be substituted with a halogen atom, an alkyl group having 1 to 10 carbon atoms, an acryl group having 2 to 10 carbon atoms or the like.
(3) Repeating unit derived from an aromatic hydroxycarboxylic acid: 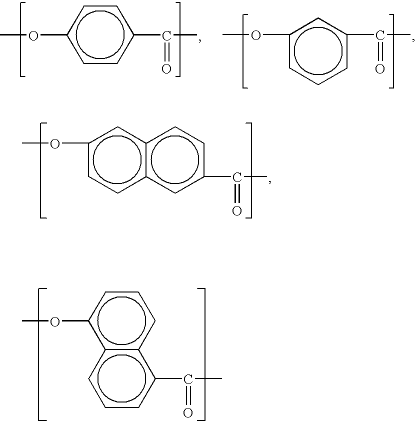
The aromatic ring in each of the above structural unit may be substituted with a halogen atom, an alkyl group having 1 to 10 carbon atoms, an aryl group having 2 to 10 carbon atoms or the like.
A liquid crystal polyester including a repeating unit: 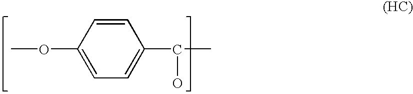
is preferable from the view point of the balance between heat resistance, mechanical properties, and processability. A liquid crystal polyester comprising the repeating units of the following (I)-(VI) is more preferable. 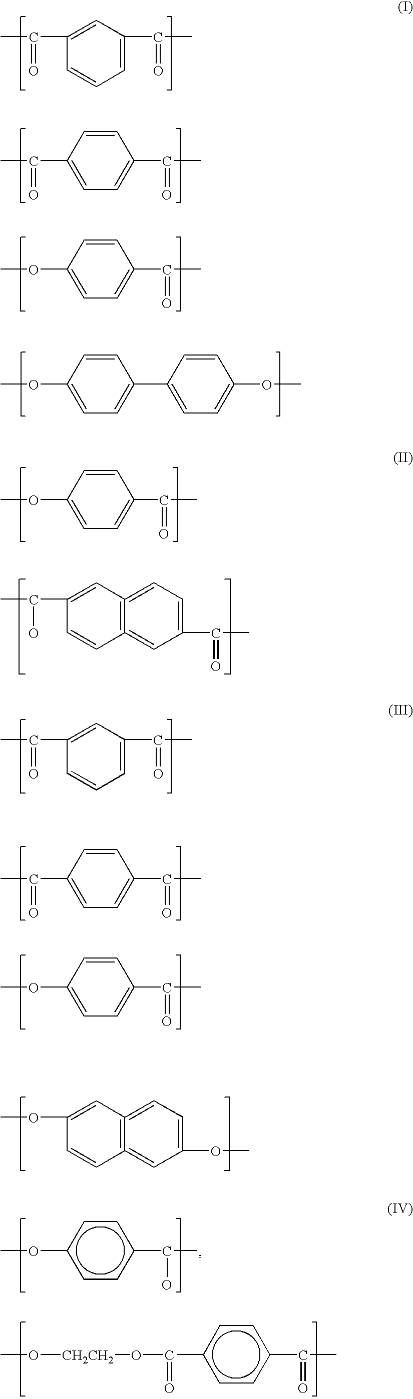 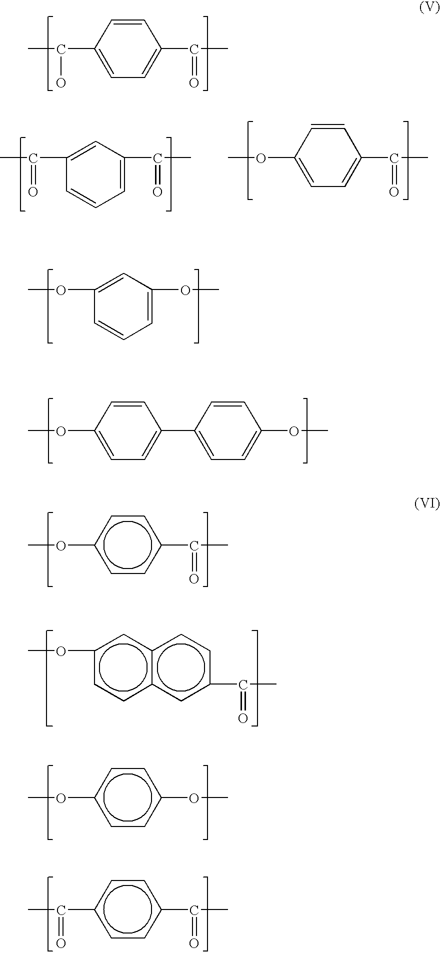
Those including at least 30 mole % of the repeating unit HC are further preferable.

Production method of the liquid crystal polyesters comprising repeating units of (I) to (VI) are disclosed in JP-B-47-47870, JP-B-63-3888, JP-B-63-3891, JP-B-56-18016, and JP-A-2-51523. Among these, a liquid crystal polyester comprising repeating units of (I) and (II), or (I) and (IV) are preferable, and (I) and (II) are more preferable.

In the case where a liquid crystal polyester is used for the field required high heat resistance, a liquid crystal polyester comprising repeating units shown in (VII) is preferable, and 30-80% by mole of repeating unit (a′), 0-10% by mole of repeating unit (b′), 10-25% by mole of repeating unit (c′) and 10-35% by mole of repeating unit (d′) is more preferably. 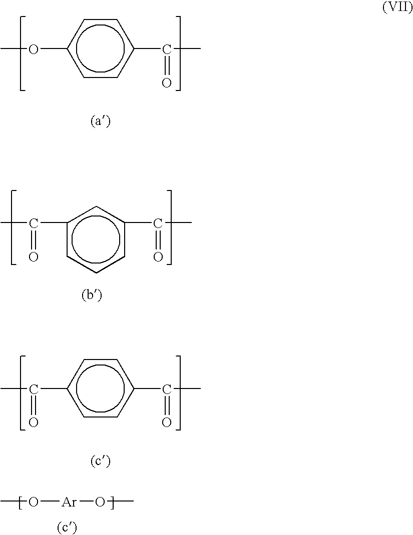
In the formula (d′), Ar is a divalent aromatic group, and examples of (d′) includes those described in above “(2) Repeating unit derived from an aromatic diol”.

From the viewpoint of an environmental concerning in the field required for easy abandonment such as incineration after use, a liquid crystal polyester having elements of only carbon, hydrogen and oxygen is used especially preferably, among the suitable combinations of repeating units required for each fields exemplified so far.

The film of the present invention comprises component A and component B, wherein the component A is at least one compound selected from a group consisting of aromatic polyamides, aromatic polyimides, and aromatic polyamideimides, and component B is a liquid crystal polymer showing optical anisotropy in molten state.

Aromatic polyamides include meta-oriented and para-oriented aromatic polyamides. Among these polyamides, meta-oriented aromatic polyamides refer to one substantially consisting of repeating units coupling by amide bonds at meta position or its corresponding position of aromatic rings (for example, 1,3-phenylene, 3,4′-biphenylene, 1,6-naphthalene, 1,7-naphthalene, 2,7-naphthalene and the like), in which polyamides are obtained by a condensation polymerization of meta-oriented aromatic diamines and meta-oriented aromatic dicarboxylic dichlorides. Examples of the meta-oriented aromatic polyamides include polymetaphenyleneisophthalamide, poly(metabenzamide), poly(3,4′-benzanilideisophthalamide), poly(metaphenylen-3,4′-biphenylene dicarboxylic amide), poly (metaphenylen-2,7-naphthalene dicarboxylic amide).

On the other hand, para-oriented aromatic polyamides refer to one substantially consisting of repeating units coupling by amide bonds at para position or its corresponding position of aromatic rings (e.g. orientation in opposite coaxial or parallel position, such as 4,4′-biphenylene, 1,5-naphthalene, 2,6-naphthalene, and the like), in which polyamides are obtained by a condensation polymerization of para-oriented aromatic diamines and para-oriented aromatic dicarboxylic dichlorides. Examples of the para-oriented amides include poly(paraphenylene terephthalic amide), poly(parabenzamide), poly(4,4′-benzanilideterephthalamide), poly(paraphenylene-4,4′-biphenlylene dicarboxylic amide), poly(paraphenylene-2,6-naphthalene dicarboxylic amide), poly(2-chloro-paraphenylene terephthalic amide), para-oriented aromatic polyamide obtained by a condensation polymerization of paraphenylene diamine and 2,6-dichloroparaphenylene diamine and terephthaloyl dichloride.

Also, in the present invention, para-oriented aromatic polyamide in which a terminal functional group of the polyamide are phenolic hydroxyl group is preferable. Para-oriented aromatic polyamide in which a terminal group of the para-oriented aromatic polyamide is phenolic hydroxyl group refers to para-oriented aromatic polyamide terminated hydroxyl group in which a part or all of the terminal functional groups of the para-oriented aromatic polyamide are hydroxyl groups.

Next, aromatic polyimides used as a component A of the film of the present invention include one obtained from condensation polymerization of aromatic dicarboxylic dianhydrides and diamines. The dicarboxylic acid dianhydrides include pyromellitic dianhydride, 3,3′,4,4′-diphenylsulfonetetracarboxylic acid dianhydride, 3,3′,4,4′-benzophenonetetracarboxylic acid dianhydride, 2,2′-bis(3,4-dicarboxyphenyl)hexafluoropropane, 3,3′,4,4′-biphenyltetracarboxylic acid dianhydride and the like. Also, examples of the diamines include oxydianiline, paraphenylenediamine, benzophenonediamine, 3,3′-methylenedianiline, 3,3′-diaminobenzophenone, 3,3′-diaminobenzosulfone and the like.

Aromatic polyamideimides used as a component A in the film of the present invention include one obtained by a condensation polymerization of aromatic dicarboxylic acids and aromatic diisocyanates, or of aromatic diacid anhydrides and aromatic diisocyanates. Examples of aromatic dicarboxylic acids include isophthalic acid, terephthalic acid. Examples of aromatic diacid anhydrides include trimellitic anhydride. Examples of aromatic diisocyanates include 4,4′-diphenylmethane diisocyanate, 2,4-tolylene diisocyanate, 2,6-tolylene diisocyanate, orthotolylane diisocyanate, m-xylene diisocyanate and the like.

The film in which component A consists of para-oriented aromatic polyamide is preferable, because the water absorbency of the film is particularly low.

Then, the film of the present invention can be included additives including plasticizer and the like without interfering the effect of the present invention.

Wherein, the component A and B are mixed in the film. In the film, it is preferable that the component A and B are mixed in a form of microscopic mixture. The form of microscopic mixture includes (1) which either of the component A or B is a form of matrix, and the other component is a form of particulate or fibrillated fiber, and the later form exists in the matrix, (2) which either of the component A or B is fibril, the other component is a form of matrix, and exists in the gapping among network structure formed the fibril and the like. The form (2) is preferable. Among the form (2), it is more preferable that the component A is fibril, because the resulting film has high-strength and good dimensional stability. In the form of (1) and (2), diameter of fibril is preferably 50 μm or less, more preferably, 10 μm or less, and more preferably 1 μm or less in terms of thinner film thickness.

Then, the component A and B are combined in the film. The combined ratio of component A/component B is preferably 1/10 to 10/1 (w/w). If component A/component B is less than 1/10 (If the amount of the liquid crystal polymer showing optical anisotropy is too high), the resulting film tends to lower the dimensional stability. If component A/component B is more than 1/10 (If the amount of the liquid crystal polymer showing optical anisotropy is too low), the water absorbency of the film tends to high.

The thickness of the film of the present invention is, but is not limited to, preferable 10 to 150 μm, more preferably 20 to 100 μm for printed wiring board. If the thickness of the film is less than 10 μm, the film tends to get wrinkles and present a problem with handling. If the thickness is more than 150 μm, the film tends not to have lightweight and thin.

Also, the film of the present invention can be laminated other films without interfering the effect of the present invention. For example, a film only consisting of liquid crystal polymers having optical anisotropy in molten state may be laminated on the film of the present invention.

The film of the present invention can be suitably used for printed wiring boards, because the film has a good heat resistance, good dimensional stability, low water absorbency and good mechanical properties. Printed wiring boards obtained by using the film of the present invention can be produced by known methods, (e.g., see “All about printed circuit boards”, Electronic Engineering (June, 1986), supplementary volume). In other words, the film of the present invention are used as insulating layer, and laminated conducting layer consisting of metal foil to make laminated material for printed circuit boards. Metal foil can be used gold, silver, copper, nickel and aluminum and the like.

Next, the method for producing the film of the present invention will be described.

The film of the present invention can be produced by a method comprising the following steps (a) to (d):
(a) preparing a solution containing component A and B, in which ratio of the component A/ the component B is 1/10 to 10/1, in organic solvent, and forming the solution to a film-like material;
(b) depositing the component A from the film-like material obtained in step (a) under humidification to obtain a deposited film;
(c) dipping the deposited film obtained in step (b) in aqueous solution or alcoholic solution to elute the organic solvent, and to dry and to obtain a prefilm;
(d) heating and/or pressurizing the prefilm obtained in step
(c) to obtain the film.

The solution containing component A and B, in which ratio of the component A/ the component B is 1/10 to 10/1, used in step (a) can be produced, for example, by preparing a solution of the component A in organic solvent, and combining ground product of component B to the solution.

As organic solvents, polar amide type solvent or polar urea type solvent are usually used. Example of polar amide type solvent include N,N-dimethyl formamide, N,N-dimethyl acetamide, N-methyl-2-pyrrolidone and the like. Example of polar urea type solvent include N,N,N′,N′-tetramethylurea and the like. Among these solvents, N-methyl-2-pyrrolidone is particularly preferable.

To improve solubility the component A to organic solvents, alkaline metal or alkaline earth metal chlorides may be used. Example of alkaline metal or alkaline earth metal chlorides include lithium chloride or calcium chloride. The amount of alkaline metal or alkaline earth metal chlorides in the solution of the component A is usually 1 to 10%, more preferably 2 to 8% by weight based on the weight of the solution. If the amount of alkaline metal or alkaline earth metal chlorides is less than 1% by weight, the solubility the component A is insufficient. If the amount of these chlorides is more than 10% by weight, alkaline metal or alkaline earth metal chlorides may not be insoluble in polar amide type solvents or polar urea type solvents.

The concentration of the component A in the solution is preferably 0.1 to 10% by weight, more preferably 1 to 10% by weight, more preferably 1.3 to 4% by weight based on the weight of the solution. If the concentration of the component A is less than 0.1% by weight, productivity may decrease, resulting in industrial disadvantage. If the concentration of the component A is more than 10% by weight, the component A may be deposited and making stable solution may be difficult.

Preferably, component A in step (a) has an intrinsic viscosity (“intrinsic viscosity” refers to one as defined hereinafter) of 1.0 to 2.8 dl/g, more preferably, 1.5 to 2.6 dl/g. If the intrinsic viscosity is less than 1.0 dl/g, film strength can be insufficient. If the intrinsic viscosity is more than 2.8 dl/g, the component A may be deposited and making the film may be difficult.

However, component A may be difficult to solve in organic solvent, in this case, starting monomer of component A can be polymerized in the organic solvent to produce component A, the resulting solution can be used as a solution of component A. Particularly, para-oriented aromatic polyamide is insoluble in organic solvent, the solution are used.

Example of the solution of component A, for example, of para-oriented aromatic polyamide can be suitably produced by the following procedure. In a solution of alkaline metal or alkaline earth metal chlorides of 1 to 10% by weight, acting as solubilizing agent, in polar amide type solvents of polar urea type solvents, 0.94 to 0.99 mol of para-oriented aromatic dicarboxylic acid halides per 1.0 mol of para-oriented aromatic diamine are added, and they can be carried out condensation polymerization at −20 to 50° C. to produce a solution of para-oriented aromatic polyamide in which the concentration of the polyamide is 0.1 to 10% by weight. Also, to the solution of para-oriented aromatic polyamide can be added a neutralizing agent to neutralize hydrochloric acid by producing condensation polymerization as side product to produce para-oriented aromatic polyamide. Examples of neutralizing agent include calcium oxide, calcium hydroxide, and calcium carbonate.

A preferable example of component A used in step (a) include para-oriented aromatic polyamide. This can be produced by condensation polymerization. Examples of para-oriented aromatic diamines used in the condensation polymerization can include paraphenylene diamine, 4,4′-diaminobiphenyl, 2-methylparaphenylenediamine, 2-chloro-paraphenylenediamine, 2,6-dichloroparaphenylenediamine, 2,6-naphthalenediamine, 1,5-naphthalenediamine, 4,4′-diaminobenzanilide, 3,4′-diaminodiphenylether and the like. These para-oriented aromatic diamines can be mixed one or two or more to subject to condensation polymerization.

Examples of para-oriented aromatic dicarboxylic acid dihalides used in condensation polymerization of para-oriented aromatic polyamide include terephthalic acid dichloride, biphenyl 4,4′-dicarboxylicacidchloride, 2-chloroterephthalic acid dichloride, 2,5-dichloroterephthalic acid dichloride, 2-methylterephthalic acid dichloride, 2,6-naphthalene dicarboxylic acid chloride, 1,5-naphthalene dicarboxylic acid chloride and the like. These para-oriented aromatic dicarboxylic acid dihalides can be mixed one or two or more to subject to condensation polymerization.

To the resulting solution of component A can be added a component B to mix and produce a solution comprising component A and B.

Liquid crystal polymer showing optical anisotropy in molten state is almost insoluble in the solution of component A, and ground product of component B is usually dispersed in the solution of component A. When ground product of component B is added in the solution of component A, the size of the ground product is preferably less than 500 μm. If the size is more than 500 μm. When coating, uneven thickness may be resulted in by “line tracing” the ground product.

If component B and the solution of component A are needed to mix, apparatus allowing component B to dispense strongly is preferably, Gorlin homogenizer, high speed mixer, supersonic homogenizer, pearl mill, disk mill and the like is preferably used.

In step (a), film-like material can be produced by flow casting the solution of component A, for example, on substrate such as glass plate or polyester film while maintaining the conformation as a film-like material. Flow casting method can be method using apparatus such as bar-coder or T-die.

In step (b), a deposited film are obtained by depositing the component A from the film-like material obtained in step (a) under humidification. The deposited film is usually a porous film including organic solvent. After forming the film-like material from the solution in step (a), it is preferable that the film-like material is maintained in air having a temperature of 20° C. or more and/or humidity of 0.01 kg of vapor/1 kg of dry air (it shows that 0.01 kg of vapor is contained in 1 kg of dry air.) or more, and that component A is deposited from the film-like material. If the temperature is less than 20° C., it takes a lot of time to deposit the component A. If the humidity is less than 0.01 kg of vapor/1 kg of dry air, it takes a lot of time to deposit the component A, resulting in industrial disadvantage.

In step (c), the deposited film obtained in step (b) are dipped in aqueous solution or alcoholic solution to elute organic solvent and to dry and to obtain a prefilm. Then, it is preferable that solvents and chlorides of alkaline metal or alkaline earth metal are removed from the film-like material obtained in step (b). Methods for removing solvents and chlorides of alkaline metal or alkaline earth metal include, for example, a method for dipping the film-like material in aqueous solution or alcoholic solution to elute organic solvent and chlorides. If organic solvent are evaporated from film-like material, a method for re-dipping aqueous solution or alcoholic solution to elute chlorides are applicable. A solution for eluting organic solvent or chlorides is preferable aqueous solution or alcoholic solution, because both organic solvent and chlorides can be removed. Also, water as aqueous solution may be used.

A prefilm is obtained by drying the deposited film removed organic solvent and chlorides. A method for drying the deposited film is not limited, conventional apparatus used in industry such as hot air dryer, infra-red dryer, vacuum dryer and the like can be used. A temperature for drying the deposited film is usually 50° C. or more under vacuum, preferably 100° C. or more.

In step (d), a film is obtained by heating and/or pressurizing the prefilm obtained in step (c). Because the prefilm is usually porous film, the prefilm is subjected to heat and/or pressure to form more dense film. Examples of process for heating and/or pressurizing include a compression by heat press, a calendering process by calender rolls and the like. Among them, the calendering process by calender is preferable with the object of consecutive processing.

Also, the film of the present invention can be produced by a method comprising the following step (f) in place of step (b):
(f) dipping the film-like material obtained in step (a) in a solution containing 0.1 to 70% by weight of polar amide type solvents or polar urea type solvents to deposit the component A and to obtain a deposited film.

In step (f), the film-like material obtained in step (a) is dipped in coagulating solution to deposit the component A and to obtain the deposited film. As coagulating solution, an aqueous solution containing 0.1 to 70% by weight, preferably 10 to 50% by weight of polar amide type solvent or polar urea type solvent is used. A deposited film can be obtained by dipping the film-like material in this coagulating solution to deposit component A.

Also, the film of the present invention can be produced by a method for producing comprising the following step (j) in place of step (b):
(j) leaving the film-like material obtained in step (a) in high temperature to evaporate solvents and to deposit the component A and to obtain a deposited film.

In the step (j), component A is deposited by evaporating solvents from the film-like material obtained in step (a) in high temperature. The temperature for evaporating solvents, adjusted by the boiling point of solvents, is usually 50° C. or more, preferably 100° C. or more.

Additionally, the film of the present invention can be produced by a method comprising the following step (m) in place of step (a) in a sequence of step (a), (b), (c) and (d), or in a sequence of step (a), (f), (c) and (d), or in a sequence of step (a), (j), (c) and (d):
(m) preparing a solution of 0.1 to 10% by weight of component A in organic solvents and applying the solution on the film consisting of component B, so that ratio of the component A/ the component B is 1/10 to 10/1, to obtain a film-like material.

In the step (m), the ground product of component B may have been previously included in the solution of component A.

The film of the present invention can be used alone for a printed wiring board. The film of the present invention may be used for a printed wiring board by laminating a blend the film and thermoplastic resins and/or thermosetting resins. In the latter case, thermoplastic resins used include, but are not limited to, resins having thermoplastic property, preferably thermoplastic resins having a melting point of 150° C. or more with the object of heat resistance. Example of thermoplastic resins can include at least one thermoplastic resins selected from polyethersulfone, polysulfone, polyetherimide, polysulfidesulfone, polycarbonate, polyimide, polyamideimide, polyetherketone. These thermoplastic resins can be used alone or in combination with each other.

Then, thermosetting resin includes at least one of thermosetting resins selected from bismaleimide-triazine resin, polyimide resin, diallylphthalate resin, unsaturated polyester resin, cyanate resin, aryl-modified polyphenylene ether resin. These thermosetting resins can be used alone or in combination with each other.

Thermoplastic resins and thermosetting resins may be used alone or in combination with each other.

The film of the present invention has a coefficient of linear thermal expansion (planer direction) of the range of ±50×10⁻⁶/° C., preferably the range of ±25×10⁻⁶/° C. at 200 to 300° C. Low coefficient of linear thermal expansion indicates that the film has a good dimensional stability in planer direction. Also, the film of the present invention has a water absorbency of 3% or less, preferably 2% or less. Low water absorbency of the film results in high electrical insulating properties at the point of use. Therefore, the film of the present invention is more preferable when used for printed wiring board and the like.

In the present invention, various additives can be used for the purpose of the application including short fiber and/or pulp and the like. For example, in order to decrease dielectric constant or water absorbency, materials having low dielectric constant and high water repellency such as polytetrafluoroethylene and the like may be positioned in or on the porous film in a form of acicular particles, particulates, or flat bars and the like. Addition of alumina short fibers and the like is effective in order to increase coefficient of thermal conductivity and strength of the film.

Also, micronized powders may be added in the film of the present invention in order to increase a mechanical strength of the film. Methods for adding these various of additives include, but are not limited to, a method for previously adding to a solution, for example, consisting of para-oriented polyamide, and the like.

### EXAMPLES

The following examples are described in more detail, but the present invention is not limited within the scope of the examples. Then, studies, evaluation methods or criteria in examples and comparative examples are as follows.

(1) Intrinsic Viscosity

A solution of 0.5 g of para-oriented aromatic polyamide polymer in 100 ml of 96-98% sulfuric acid was prepared. The solution and 96-98% sulfuric acid were measured their flow times by a capillary viscometer at 30° C., respectively. Using the ratio of their resulting flow times, intrinsic viscosity of the polymer was determined according to the following calculating formula.
intrinsic viscosity=1n(T/T₀)/C (unit: dl/g)
wherein T and T₀ is the flow time of the solution of para-oriented aromatic polyamide in sulfuric acid and sulfuric acid, respectively; C is a concentration (g/dl) of para-oriented aromatic polyamide in the solution of para-oriented aromatic polyamide in sulfuric acid and sulfuric acid.
(2) Water Absorbency

Test pieces were dried at 120° C. for 2 hours, and then maintained under a relative humidity of 65% at 25° C. for 24 hours. The change of weight of test pieces was measured. Test pieces were used in a form of square 100 mm on a side.

(3) Coefficient of Linear Thermal Expansion

The length of the test pieces before the test and the change of length of test pieces after the test were measured by the thermal analysis equipment TMA120 (Seiko Instruments Inc.) according to ASTMD696. Coefficient of linear thermal expansion was calculated by the following calculating formula. However, for test pieces without annealing before measurement, the length of the test pieces before the test is the measurement of test pieces after heating to 300° C. in the equipment.
α1=ΔL/L₀·ΔT
Wherein
α1: coefficient of linear thermal expansion (/° C.)
ΔL: the change of length of test pieces after the test
L₀: the length of the test pieces before the test
ΔT: difference in temperature (° C.)

### Example 1

(1) Synthesis of Poly(Paraphenylene Terephthalic Amide)

Poly(paraphenylene terephthalic amide) (refers to “PPTA” hereinafter) was prepared in 5 L of separable flask equipped with stirring impella, thermometer, inflow tube, and opening for adding powder. The flask was dried adequately, and 4200 g of N-methyl 2-pyrrolidone (refers to NMP hereinafter) were charged in the flask and added 272.7 g of calcium chloride previously dried at 200° C. for 2 hours, and heated to 100° C. After dissolving thoroughly calcium chloride, cooled to room temperature, 132.9 g of paraphenylene diamine (refers to “PPD” hereinafter) was added to the reactant to dissolve PPD thoroughly. The resulting solution was maintained at 20±2° C., and added 243.3 g of terephthaloyl dichloride (refers to “TPC” hereinafter) in ten portion every 5 minutes. After that, the solution was maintained at 20±2° C., and stirred under vacuum in order to defoam. The resulting polymer solution (polymer dope) showed optical anisotropy. Apart of the solution was taken and re-precipitated from water to obtain polymer. The intrinsic viscosity of the resulting hydroxyl-terminated PPTA was 1.96 dl/g.

(2) Preparation of Film

The film comprising a para-oriented aromatic polyamide and a liquid crystal polymer showing optical anisotropy in molten state was prepared from the polymer solution prepared in (1). 100 g of the polymer solution was charged in 500 mL of separable flask equipped with stirring wing, thermometer, inflow tube, and opening for adding powder, and stirred under nitrogen atmosphere. After adding 200 g of NMP to the resulting reactant, 1.41 g of calcium oxide was added and neutralized the resulting hydrochloric acid, and then filtered on a 1000 mesh metal gauze. Next, 18 g of whole aromatic polyester powder having about 10 to 100 μm and showing optical anisotropy in molten state (corresponds to 300 part by weight per 100 part by weight of para-oriented aromatic polyamide) was weighed, and added in the flask, and stirred for 120 minutes. The whole aromatic polyester powder was dispersed thoroughly in the solution by passing the resulting mixture through Gorin homogenizer three times. After that, the dispersion was defoamed under vacuum to obtain dope for coating. A film was produced by the resulting dope for coating according to the following procedure. Firstly, 25 mm in diameter of stainless-steel bars were parallel-positioned on a 100 μm of thickness of PET film held on a roll so that clearance between PET film and each of the stainless-steel bars is 0.8 mm. PET film was rolled up and moved in parallel while supplying the dope for coating to coat the dope on the PET film and to obtain a film-like material. The film-like material was maintained at 60° C. and 40% of relative humidity for about 5 minutes to deposit PPTA and to obtain the deposited film. 100 μm of PET film and the deposited film in a integrated form was dipped in deionized water, and washed for 2 hours while flowing deionized water. After washing, PET film was taken out. The resulting film only was sandwiched between two aramid felts, and pushed it to heated drum having 1000 mm in diameter, and heated at 120° C. for 10 minutes. The resulting prefilm was heat pressed at 320° C. and 50 kg/cm² to obtain the film comprising PPTA and whole aromatic polyester powder. The resulting film has a 30 μm of thickness, and the observation of the fine structure of the section by using SEM shows that whole aromatic polyester existed between the fibrils of para-oriented aromatic polyamide of which diameter is about 0.1 μm. Further, the coefficient of linear thermal expansion of the film was 2×10⁻⁶/° C. at 200 to 300° C., and water absorbency of the film was 1.5%.

### Example 2

The film comprising a para-oriented aromatic polyamide and a liquid crystal polymer showing optical anisotropy in molten state was prepared from the polymer solution prepared in Example 1 (1). 100 g of the polymer solution was charged in 500 mL of separable flask equipped with stirring wing, thermometer, inflow tube, and opening for adding powder, and stirred under nitrogen atmosphere. After adding 200 g of NMP to the resulting reactant, 1.41 g of calcium oxide was added and neutralized the resulting hydrochloric acid, and then filtered on 1000 mesh metal gauze. Next, 18 g of whole aromatic polyester powder having about 10 to 100 μm and showing optical anisotropy in molten state (corresponds to 300 part by weight per 100 part by weight of para-oriented aromatic polyamide) and 3.0 g of aramid powder having about 30 to 50 μm (Towaron 5011 (Trade name) was weighed, and added in the flask, and stirred for 120 minutes. The whole aromatic polyester powder and the aramid powder were dispersed thoroughly in the solution by passing the resulting mixture through Gorin homogenizer three times. After that, the dispersion was defoamed under vacuum to obtain dope for coating. A film was produced by the resulting dope for coating by a similar method described in Example 1 (2). The film has a 40 μm of thickness and the observation of the fine structure of the section by using SEM shows that whole aromatic polyester existed between the fibrils of para-oriented aromatic polyamide of which diameter is about 0.1 μm. Additionally, aramid powder was dispersed in the film. The coefficient of linear thermal expansion was 1×10⁻⁶/° C. at 200 to 300° C., and water absorbency of the film was 0.7%.

### Example 3

The film comprising a para-oriented aromatic polyamide and a liquid crystal polymer showing optical anisotropy in molten state was prepared from the polymer solution prepared in Example 1 (1). 100 g of the polymer solution was charged in 500 mL of separable flask equipped with stirring wing, thermometer, inflow tube, and opening for adding powder, and stirred under nitrogen atmosphere. After adding 200 g of NMP to the resulting reactant, 1.41 g of calcium oxide was added and neutralized the resulting hydrochloric acid, and then filtered on a 1000 mesh metal gauze. The filtrate was defoamed under vacuum to obtain dope for coating. A film was produced by the resulting dope for coating according to the following step. Firstly, 25 mm in diameter of stainless-steel bars were parallel-positioned on a 100 μm of thickness of PET film held on a roll so that clearance between PET film and each of the stainless-steel bars is 1 mm. PET film was rolled up and moved in parallel while supplying the dope for coating to coat the dope on the PET film and to obtain a film-like material. The film-like material was maintained at 60° C. and 40% of relative humidity for 5 minutes to deposit PPTA and to obtain the deposited film. 100 μm of PET film and the deposited film in a integrated form was dipped in deionized water, and washed for 12 hours while flowing deionized water. After washing, PET film was taken out. The resulting film only was sandwiched between two aramid felts, and pushed it to heated drum having 1000 mm in diameter, and heated at 120° C. for 10 minutes. The resulting prefilm was sandwiched between 2 pieces of whole aromatic polyester film having 20 μm and showing optical anisotropy, and heat pressed at 320° C. and 50 kg/cm² to obtain a film consisting aramid and whole aromatic polyester showing optical anisotropy. The film has 50 μm of thickness and the observation of the fine structure of the section by using SEM shows that whole aromatic polyester existed between the fibrils of para-oriented aromatic polyamide of which diameter is about 0.1 μm. The coefficient of linear thermal expansion was 4×10⁻⁶/° C. at 200 to 300° C., and water absorbency of the film was 0.8%.

### Example 4

The film comprising a para-oriented aromatic polyamide and a liquid crystal polymer showing optical anisotropy in molten state was prepared according to the following procedure. Firstly, whole aromatic polyester film showing optical anisotropy in molten state was sandwiched between 2 prefilms using a method similar to Example 3, and heat pressed at 320° C. and 50 kg/cm² to obtain a film consisting aramid and whole aromatic polyester showing optical anisotropy. The film has 50 μm of thickness and the observation of the fine structure of the section by using SEM shows that whole aromatic polyester existed between the fibrils of para-oriented aromatic polyamide of which diameter is about 0.1 μm. The coefficient of linear thermal expansion was 1.3×10⁻⁶/C at 200 to 300° C., and water absorbency of the film was 0.5%.

1. A film comprising component A and component B, wherein the component A is at least one compound selected from a group consisting of aromatic polyamides, aromatic polyimides, and aromatic polyamideimides, and component B is a liquid crystal polymer showing optical anisotropy in molten state.

2. The film according to claim 1, wherein the component A and the component B is in a form of microscopic mixture.

3. The film according to claim 2, wherein the form of microscopic mixture is the form in which one of the components A and B is a form of matrix, and the other component is a form of particulate or fibril and exists in the matrix.

4. The film according to claim 2, wherein the form of microscopic mixture is the form in which one of the components A and B is fibril, the other component is a form of matrix and exists in the gap among network structure formed the fibril.

5. The film according to claim 3, wherein the diameter of the fibril is 50 μm or less.

6. The film according to claim 1, wherein the weight ratio of component A/component B is preferably 10/1 to 1/10 (w/w).

7. The film according to claim 1, wherein the component A is para-oriented aromatic polyamides.

8. The film according to claim 7, wherein the water absorbency of the film is not more than 3% by weight, and coefficient of linear thermal expansion is within ±50×10⁻⁶/° C. at 200 to 300° C.

9. A method for producing the film according to claim 1, comprising the following steps (a) to (d):
(a) preparing a solution containing components A and B so that the weight ratio of the component A/ the component B is 1/10 to 10/1, in an organic solvent, and forming the solution to a film-like material;
(b) depositing the component A from the film-like material obtained in step (a) under humidification to obtain a deposited film;
(c) dipping the deposited film obtained in step (b) in aqueous solution or alcoholic solution to elute the organic solvent, and drying the resulting film to obtain a prefilm;
(d) heating and/or pressurizing the prefilm obtained in step (c) to obtain a film.

10. A production method comprising the following step (f) in place of step (b) in the production method according to claim 9:
(f) dipping the film-like material obtained in step (a) in a solution containing 0.1 to 70% by weight of polar amide type solvents or polar urea type solvents to deposit the component A and to obtain a deposited film.

11. A production method comprising the following step (j) in place of step (b) in the production method according to claim 9:
(j) leaving the film-like material obtained in step (a) in high temperature to evaporate solvents and to deposit the component A and to obtain a deposited film.

12. A production method comprising the following step (m) in place of step (a) in the production method according to claim 9:
(m) preparing a solution of 0.1 to 10% by weight of component A in organic solvents and applying the solution on the film consisting of component B so that the weight ratio of the component A/ the component B is 1/10 to 10/1, to obtain a film-like material.

13. A printed wiring board obtained by using the film according to claim 1.

14. The film according to claim 4, wherein the diameter of the fibril is 50 μm or less.

15. A production method comprising the following step (m) in place of step (a) in the production method according to claim 10:
(m) preparing a solution of 0.1 to 10% by weight of component A in organic solvents and applying the solution on the film consisting of component B so that the weight ratio of the component A/ the component B is 1/10 to 10/1, to obtain a film-like material.

16. A production method comprising the following step (m) in place of step (a) in the production method according to claim 11:
(m) preparing a solution of 0.1 to 10% by weight of component A in organic solvents and applying the solution on the film consisting of component B so that the weight ratio of the component A/ the component B is 1/10 to 10/1, to obtain a film-like material.
